(19) United States
(12) Patent Application Publication
(10) Pub. No.: US 2011/0180113 A1
(43) Pub. Date: Jul. 28, 2011

(54) METHOD OF WAFER CLEANING AND APPARATUS OF WAFER CLEANING

(76) Inventors: Chin-Cheng Chien, Tainan Hsien (TW); Chun-Yuan Wu, Yunlin County (TW)

(21) Appl. No.: 12/695,173

(22) Filed: Jan. 28, 2010

(51) Int. Cl. B08B 3/00

(52) U.S. Cl. 134/32; 134/151

(57) ABSTRACT

A method of cleaning wafer cleaning includes: first a wafer stage for holding and rotating a wafer is provided. The wafer has a surface to be washed. A nozzle is positioned on the wafer for spraying a cleaning solution. The nozzle moves in non-uniform motion from a first given point to a second given point so as to make the time which the first given point is exposed to the cleaning solution equal to the time which the second given point is exposed to the cleaning solution. Furthermore, the nozzle moves faster when passing the center of the wafer and moves slower when passing the edge of the wafer.

### BACKGROUND OF THE INVENTION

1. Field of the Invention

The present invention relates to a method of wafer cleaning, more particularly to a method of wafer cleaning capable of increasing the uniformity of the surface of the wafer.

2. Description of the Prior Art

The formation of a semiconductor device includes a lot of steps, such as implantation of dopants, formation of a gate oxide layer, deposition of a metal layer, etching process, and chemical mechanical polishing. It is well-known that there is a need to clean a wafer where a fabrication operation has been performed that leaves unwanted residues on the surfaces, edges, bevels, and notches of wafers.

One wafer cleaning method commonly employed is wet cleaning. Generally, during a cleaning process, a cleaning solution such as deionized water, or other cleaning solutions is utilized to clean residues on a wafer, and the deionized water or cleaning solutions along with the residues is spun out of the surface of the wafer. During the cleaning process not only the residues but also some of the material layers on the wafer are removed by the cleaning solution.

A traditional wafer cleaning device includes a liquid supply system including a plurality of pipes, and a plurality of nozzles, each connecting to one end of the pipe. However, because the tangential velocity is different at the outer circle and the inner circle of the wafer, the cleaning solution at the edge will be spun out more quickly than the cleaning solution at the center of the wafer. Therefore, points on the wafer have different distances away from the center will have different exposed times to the cleaning solution. Accordingly, the residues and the material layers on the wafer are removed unevenly by the cleaning solution, and the uniformity of the surface of the wafer is deteriorated.

### SUMMARY OF THE INVENTION

In light of above, the present invention provides a novel method of wafer cleaning and a novel apparatus for wafer cleaning to solve the above-mentioned problem.

According to a preferred embodiment of the present invention, a method of wafer cleaning includes: first, providing a wafer stage for holding and rotating a wafer, wherein the wafer has a surface to be washed, and a nozzle is positioned on the wafer for spraying a cleaning solution onto the surface. Then, a cleaning process is performed by rotating the wafer and moving the nozzle in non-uniform motion from a first given point to a second given point on the surface of the wafer so as to make the time which the first given point is exposed to the cleaning solution equal to the time which the second given point is exposed to the cleaning solution.

According to another preferred embodiment of the present invention, a method of wafer cleaning includes: first, providing a wafer stage for holding and rotating a wafer, wherein the wafer has a surface to be washed, and a first nozzle is positioned on the wafer for spraying a cleaning solution onto the surface. Then, a cleaning process is performed by rotating the wafer and spraying the cleaning solution by the first nozzle onto a first given point and a second given point on the surface of the wafer so as to make the time which the first given point is exposed to the cleaning solution equal to the time which the second given point is exposed to the cleaning solution, wherein the flow rate of the cleaning solution sprayed from the first nozzle decreases non-uniformly when the first nozzle moves from the first given point to the second given point.

According to another preferred embodiment of the present invention, a wafer cleaning apparatus, comprising: a wafer stage for holding a wafer, the wafer having a surface to be washed, the surface having a first given point and a second given point, a first nozzle positioned on the wafer distant from the center of the wafer for spraying a clean solution onto the surface and a second nozzle positioned on the wafer near the center of the wafer for spraying the cleaning solution onto the surface, wherein the flow rate of the cleaning solution sprayed from the first nozzle is different from the flow rate of the cleaning solution sprayed from the second nozzle so as to make the time which the first given point is exposed to the cleaning solution equal to the time which the second given point is exposed to the cleaning solution.

The nozzle in the present invention is moved in non-uniform motion. More particularly, the moving rate of the nozzle at the edge of the wafer is slower than the moving rate of the nozzle at the center of the wafer. Therefore, the exposed time to the cleaning solution of each point on the wafer is equal, and the uniformity of the surface of the wafer after cleaning process is increased. In addition, the present invention also controls the flow rate of the cleaning solution sprayed from the nozzle. The flow rate of the cleaning solution sprayed from the nozzle depends on the position of the nozzle relative to the radius of the wafer. In this way, the exposed time to the cleaning solution of each point on the wafer can be equal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a method of wafer cleaning according to a first preferred embodiment of the present invention.

FIG. 2 depicts a broken line graph of the moving rate of the nozzle vs. the position of the nozzle according to a first preferred embodiment of the present invention.

FIG. 3 depicts a method of wafer cleaning according to a second preferred embodiment of the present invention.

FIG. 4 depicts a broken line graph of the moving rate of the nozzle vs. the position of the nozzle according to a second preferred embodiment of the present invention.

FIG. 5 depicts a broken line graph of the staying period of the nozzle vs. the position of the nozzle according to a second preferred embodiment of the present invention.

FIG. 6 depicts a broken line graph of the flow rate of the cleaning solution vs. the position of the nozzle according to the third preferred embodiment of the present invention.

FIG. 7 depicts a method of wafer cleaning according to a fourth preferred embodiment of the present invention and a wafer cleaning apparatus.

### DETAILED DESCRIPTION

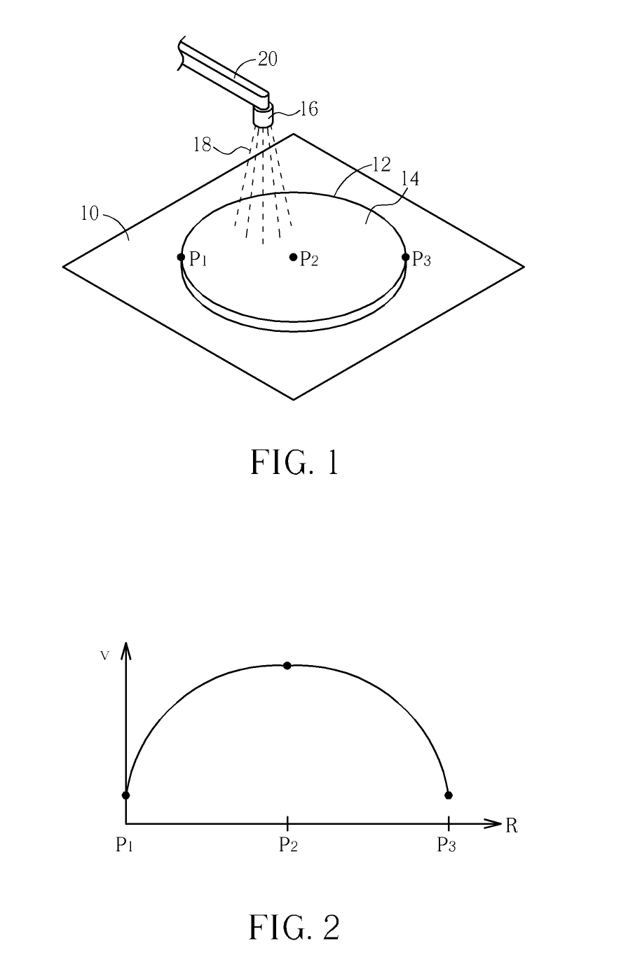

FIG. 1 depicts a method of wafer cleaning according to a first preferred embodiment of the present invention. FIG. 2 depicts a broken line graph of the moving rate of the nozzle vs. the position of the nozzle according to a first preferred embodiment of the present invention. As shown in FIG. 1, a wafer stage 10 for holding and rotating a wafer 12 is provided. The wafer 12 has a surface 14 to be washed. A nozzle 16 is positioned on the wafer 12 for spraying a cleaning solution 18 onto the surface 14. The nozzle 16 is fixed on a suspension arm 20. The nozzle 16 can be moved horizontally in a radial direction by the suspension arm 20. Next, a cleaning process is performed by moving the nozzle 16 in non-uniform motion from a first given point P1 to a second given point P2 on the surface 14 of the wafer 12 so as to make the time which the first given point P1 is exposed to the cleaning solution 18 equal to the time which the second given point P2 is exposed to the cleaning solution 18. The first given point P1 is positioned near an edge of the wafer 12, and the second given point P2 is positioned near the center of the wafer 12. Preferably, in the FIG. 1, the first given point P1 is positioned at an edge of the wafer 12, and the second given point P2 is positioned at the center of the wafer 12. During the cleaning process, the wafer 12 is rotated clockwise or counterclockwise with a rate of 300˜1000 rpm, and preferably of 500 rpm. The cleaning solution 18 sprayed from the nozzle 16 has a fixed flow rate. As shown in FIG. 2, the vertical axis shows the moving rate of the nozzle 16, and the horizontal axis shows the position of the nozzle 16 relative to the wafer 12. Please refer to FIG. 2, the nozzle 16 moves in a continuous accelerated motion from the first given point P1 to the second given point P2. In other words, the path of the nozzle 16 crosses a radius of the wafer 12. The moving rate of the nozzle 16 on the second given point P2 is faster than the moving rate of the nozzle 16 on the first given point P1. After the nozzle 16 reaches on the second given point P2, the nozzle 16 can return optionally to the first given point P1 in a continuous decelerated motion. According to different requirements, the nozzle can move between the first given point P1 and the second given point P2 repeatedly until the surface 14 is cleaned. Although only the non-uniformly accelerated/decelerated motion is shown in FIG. 2, however, the moving rate of the nozzle 16 can also be uniformly accelerated/decelerated motion. In addition, during the cleaning process, the nozzle 16 can stop at any point on the wafer for a predetermined time, and then nozzle 16 can continue to move non-uniformly later. According to the first preferred embodiment of the present invention, the moving rate of the nozzle 16 can be between 0˜100 mm/s. The moving rate of the nozzle 16 can be adjusted based on the rotation rate of the wafer, the flow rate of the cleaning solution 18, and the location of the nozzle 16. The flow rate of the cleaning solution 18 sprayed from the nozzle 16 can be between 1˜2 l/min, and preferably be 1.5 l/min. Moreover, the nozzle 16 can optionally move in non-uniform motion repeatedly passing a diameter of the wafer 12. For example, as shown in FIG. 1 and FIG. 2, a third given point P3 which is opposed to the first given point P1 can be also disposed on the surface 14. Preferably, the third given point P3 is at another edge of the wafer 12. During the cleaning process, the nozzle 16 can move from the first given point P1 to the second given point P2 in accelerated motion. After the nozzle 16 reaches the second given point P2, the nozzle 16 can move from the second point P2 to the third point P3 in decelerated motion. The nozzle 16 can move repeatedly between the first given point P1 and the third given point P3 until the surface 14 is cleaned.

The tangential velocity is positively correlated to the distance between a point and the center of the wafer. For example, the tangential velocity of a point on the edge of the wafer is greater than the tangential velocity of the center of the wafer, therefore, the cleaning solution on the center of the wafer will stay longer, and the cleaning solution on the edge will leave faster. Therefore, the residues and the material layer on each point having different distances from the center of the wafer are removed unequally by the cleaning solution. In the end, the uniformity of the surface of the wafer is deteriorated. Therefore, the first preferred embodiment feature in that the nozzle moves in non-uniform motion so as to make each point on the surface of the wafer exposed to the cleaning solution equally. Take the FIG. 1 as example, because the tangential velocity of the first given point is faster than that of the second given point, the cleaning solution will stay on the second given point longer than staying on the first given point. Therefore, as the flow rate of the cleaning solution is constant, the nozzle moves faster on the second given point to stay short on the second given point P2, and move slower on the first given point to stay longer on the first given point P1 to compensate the influence of different tangential velocity. In this way, each point on the surface of the wafer is exposed to the cleaning solution for an equal period of time.

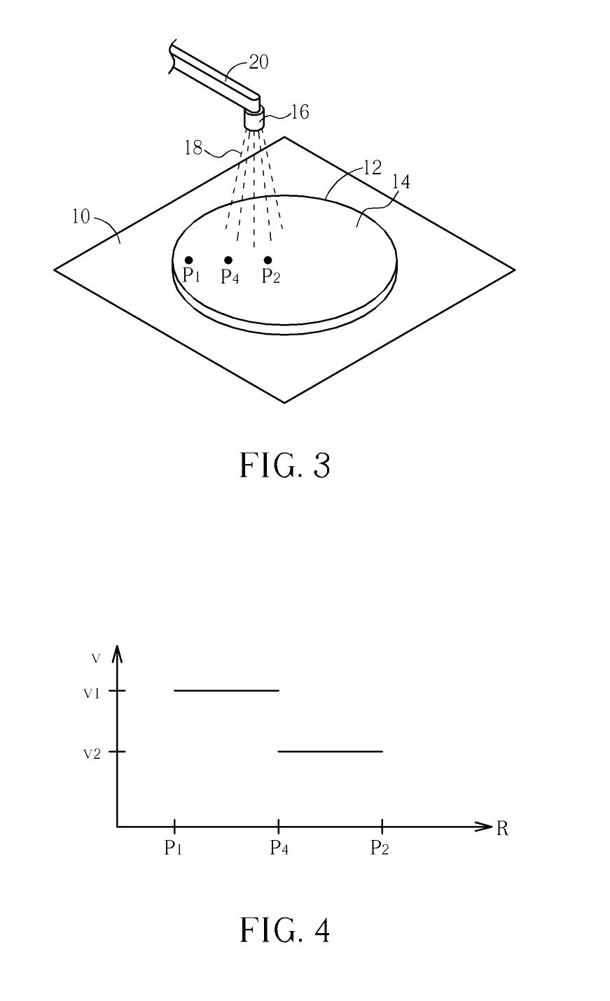

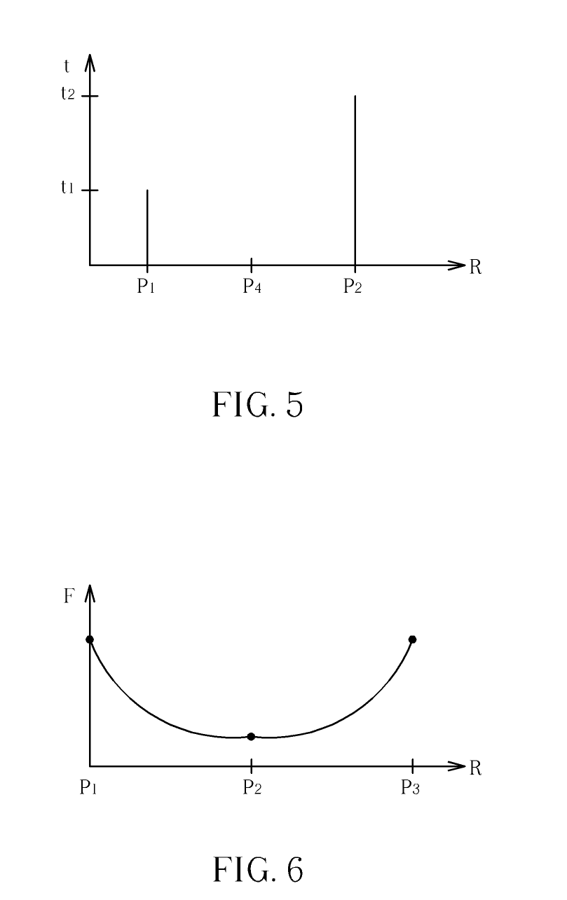

FIG. 3 depicts a method of wafer cleaning according to a second preferred embodiment of the present invention, wherein elements with the same function will be designated with the same numerals as used in FIG. 1. FIG. 4 depicts a broken line graph of the moving rate of the nozzle vs. the position of the nozzle according to a second preferred embodiment of the present invention. FIG. 5 depicts a broken line graph of the staying period of the nozzle vs. the position of the nozzle according to a second preferred embodiment of the present invention. Similar to the first preferred embodiment, the flow rate of the cleaning solution sprayed from the nozzle in the second embodiment is fixed. Different from the first preferred embodiment, the moving method of the nozzle in the second preferred embodiment is in step accelerated/decelerated motion as shown in FIG. 4. The method of wafer cleaning of the second preferred embodiment of the present invention is described as follows. In FIG. 3, a wafer 12 having a surface 14 to be washed is shown. A first given point P1, a second given point P4, and a third given point P2 is positioned on the surface 14. The first given point P1 is 15 millimeters away from the edge of the wafer 12. The second given point P4 is 40 millimeters away from the edge of the wafer 12. The third given point P2 is 15 millimeters away from the center of the wafer 12. The wafer 12 is disposed on a wafer stage 10. A nozzle 16 is fixed on a suspension arm 20, and disposed on the wafer 12. Preferably, the distance between the nozzle 16 and the surface 14 is 10 millimeters. Please refer to FIGS. 3, 4 and 5. During the cleaning process, the wafer 12 is rotated clockwise or counterclockwise. The nozzle 16 stays above the first given point P1 for a first period t1. Then, the nozzle 16 is moved by the suspension arm 20 from the first given point P1 to the second given point P4 in a first moving rate v1. Next, the nozzle 16 is moved from the second given point P4 to the third given point P2 in a second moving rate v2. After that, the nozzle 16 is moved from the third given point P2 back to the second given point P4 in the second moving rate v2. Later, the nozzle 16 is moved back from the second given point P4 to the first given point P1 in the first moving rate v1. Then, the nozzle 16 is moved again from the first given point P1 to the second given point P4, and from the second given point P4 to the third given point P2 in the aforesaid moving rate. Finally, the nozzle 16 stays at the third given point P2 for a second period t2. According to the second preferred embodiment, the first period t1 is 12 seconds, the second period t2 is 36 seconds, the first moving rate v1 is 38 mm/s, the second moving rate v2 is 30 mm/s and the rotation rate of the wafer 12 is 300 rpm. According to another preferred embodiment, the first period t1 is 12 seconds, the second period t2 is 36 seconds, the first moving rate v1 is 42 mm/s, the second moving rate v2 is 30 mm/s and the rotation rate of the wafer 12 is 300 rpm. In this way, each point on the wafer can be exposed to the cleaning solution with an equal time. Therefore, the uniformity of the surface of the wafer is increased.

A method of wafer cleaning according to a third preferred embodiment of the present invention can be shown by FIG. 1. FIG. 6 depicts a broken line graph of the flow rate of the cleaning solution vs. the position of the nozzle according to the third preferred embodiment of the present invention. Different from the first embodiment, the cleaning solution sprayed from the nozzle is not fixed. As shown in FIG. 1, a wafer stage 10 for holding and rotating a wafer 12 is provided. The wafer 12 has a surface 14 to be washed. A nozzle 16 is positioned on the wafer 12 for spraying a cleaning solution 18 onto the surface 14. The nozzle 16 is fixed on a suspension arm 20. The nozzle 16 can be moved horizontally in the radial direction by the suspension arm 20. Next, a cleaning process is performed, and the wafer 12 is rotated clockwise or counterclockwise with a rate of 300˜1000 rpm, and preferably of 500 rpm. A first given point P1, a second given point P2, and a third given point P3 are positioned on the surface 14. The first given point P1 is nearer the edge of the wafer 12 than the second given point P2 is. The second given point P2 is around the center of the wafer 12. The third given point P3 is opposed to the first given point P1, and the second given point P2 is disposed between the first given point P1 and the third given point P3. During the cleaning process, the nozzle 16 can be moved horizontally in the radial direction by the suspension arm 20. The nozzle 16 can moved repeatedly through a diameter of the wafer 12 or only moved repeatedly through a radius of the wafer 12. As shown in FIG. 6, the flow rate of the cleaning solution 18 sprayed from the nozzle 16 is not fixed. When the nozzle 16 passes the edge of the wafer 12, such as passing the first given point P1, the rate of the cleaning solution 18 sprayed from the nozzle 16 is greater, and preferably is between 1.5˜2 l/min. When the nozzle 16 passes the center of the wafer 12, such as passing the second given point P2, the rate of the cleaning solution 18 sprayed from the nozzle 16 is smaller, and preferably is between 0.7˜1 l/min. When the nozzle 16 is moved back to the third given point P3, the flow rate of the cleaning solution 18 is increased again. As mentioned above, because the tangential velocity is different in the outer circle and the inner circle of the wafer 12, the cleaning solution 18 will stay longer on the inner circle than on the outer circle, and the uniformity of the surface 14 is deteriorated. In the third preferred embodiment, the flow rate of the cleaning solution is adjusted so as to make each point on the wafer be exposed to the cleaning solution with an equal time. According to different requirements, the nozzle 18 can be moved in uniform motion or in non-uniform motion. For example, the nozzle 18 can be moved in a step accelerated/decelerated motion or in uniformly accelerated/decelerated motion or in non-uniformly accelerated/decelerated motion. Additionally, during the cleaning process, the nozzle 16 can stop at any point on the wafer for a predetermined time, and then continue to move again.

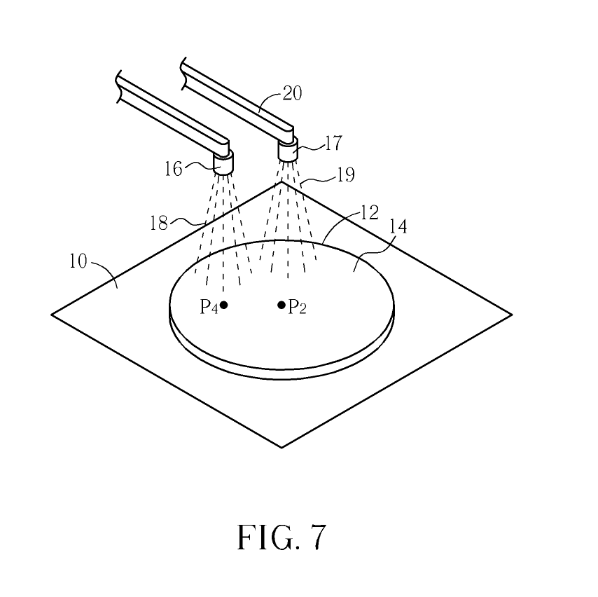

FIG. 7 depicts a method of wafer cleaning according to a fourth preferred embodiment of the present invention and a wafer cleaning apparatus, wherein elements with the same function will be designated with the same numerals as used in FIG. 1. Different from the third embodiment, there are two nozzles for cleaning the wafer in the fourth embodiment. As shown in FIG. 7, a wafer stage 10 for holding and rotating a wafer 12 is provided. The wafer 12 has a surface 14 to be washed. Two nozzles 16, 17 are positioned on the wafer 12 for spraying a cleaning solution 18, 19 respectively onto the surface 14. Other elements are described in the third embodiment, the details are therefore omitted here. During the cleaning process, the flow rate of the cleaning solution 18 sprayed from the nozzle 16 is preferably between 1.5˜2 l/min. The flow rate of the cleaning solution 19 sprayed from the nozzle 17 is preferably between 0.7˜1 l/min. The flow rate of the cleaning solution 19 and the flow rate of the cleaning solution 18 can be fixed values, or changeable values. The flow rate of the cleaning solution 18, 19 can be adjusted based on the rotation rate of the wafer. For example, the flow rate of the cleaning solution 19 can be a fixed value between 0.7˜1 l/min, and the flow rate of the cleaning solution 18 can be a changeable value changed between 1.5˜2 l/min during the cleaning process. Alternatively, the flow rate of the cleaning solution 18, 19 can both be fixed values between 0.7˜1 l/min.

A first given point P4 is disposed around or at the edge of the wafer 12, a second given point P2 is around or at the center of the wafer 12. In the FIG. 7, the first given point P4 is at the edge of the wafer 12, and the second given point is at the center of the wafer 12. The nozzle 16 is above the first given point P4, and the nozzle 17 is above the second given point P2. The flow rate of the cleaning solution 18 is greater than the flow rate of the cleaning solution 19. Besides, the nozzles 16, 17 can be in static at one location or be moved in the radial direction. For example, the nozzle 16 can be moved and the nozzle 17 can be in static. The nozzle 16 can be moved between the first given point P4 and the second given point P2. Alternatively, the nozzle 17 can be moved between the first given point P4 and the second given point P2, and the nozzle 16 can be in static. The moving rate of the nozzles 16, 17 can be in a step accelerated/decelerated motion or in uniformly accelerated/decelerated motion or in non-uniformly accelerated/decelerated motion. Additionally, during the cleaning process, the nozzles 16, 17 can stop at any point on the wafer for a predetermined time, and then continue to move later. By using the method described in the fourth embodiment, each point on the surface of the wafer can be exposed to the cleaning solution equally.

The present invention introduces a method of wafer cleaning which includes moving the nozzle in non-uniform motion. The moving rate of the nozzle is slower at the edge of the wafer than at the center of the wafer. In addition, the present invention further controls the flow rate of the cleaning solution to compensate the influence of the different tangential velocities on the wafer. In the end, each point on the wafer has equal exposed time to the cleaning solution.

Those skilled in the art will readily observe that numerous modifications and alterations of the device and method may be made while retaining the teachings of the invention.

What is claimed is:

1. A method of wafer cleaning comprising:
providing a wafer stage for holding and rotating a wafer, wherein the wafer has a surface to be washed, and a nozzle is positioned on the wafer for spraying a cleaning solution onto the surface; and
performing a cleaning process by moving the nozzle in non-uniform motion from a first given point to a second given point on the surface of the wafer.

2. The method of wafer cleaning of claim 1, wherein the first given point is positioned at an edge of the wafer, and the second given point is positioned at the center of the wafer.

3. The method of wafer cleaning of claim 1, wherein the nozzle moves in a continuous accelerated motion.

4. The method of wafer cleaning of claim 1, wherein the nozzle moves in a stepped accelerated motion.

5. The method of wafer cleaning of claim 1, wherein the moving rate of the nozzle on the second given point is greater than the moving rate of the nozzle on the first given point.

6. The method of wafer cleaning of claim 1, wherein the moving rate of the nozzle is negatively correlated to the distance between the nozzle and the center of the wafer.

7. The method of wafer cleaning of claim 1, wherein the flow rate of the cleaning solution sprayed from the nozzle is fixed.

8. A method of wafer cleaning comprising:
providing a wafer stage for holding and rotating a wafer, wherein the wafer has a surface to be washed, and a first nozzle is positioned on the wafer for spraying a cleaning solution onto the surface; and
performing a cleaning process by rotating the wafer and moving the first nozzle to spray the cleaning solution onto a first given point and a second given point on the surface of the wafer, wherein the flow rate of the cleaning solution sprayed from the first nozzle decreases non-uniformly when the first nozzle moves from the first given point to the second given point.

9. The method of wafer cleaning of claim 8, wherein the first given point is positioned near an edge of the wafer, and the second given point is positioned at the center of the wafer.

10. The method of wafer cleaning of claim 8, wherein the cleaning process comprises:
moving the first nozzle horizontally, wherein the movement of the first nozzle is in a fashion selected from the group consisting of in uniform motion and in non-uniform motion.

11. The method of wafer cleaning of claim 8, wherein the flow rate of the cleaning solution sprayed from the first nozzle decreases continuously when the first nozzle moves from the first given point to the second given point.

12. The method of wafer cleaning of claim 8, further comprising a second nozzle for spraying the cleaning solution.

13. The method of wafer cleaning of claim 12, wherein the first nozzle is more distant from the center of the wafer than the second nozzle is.

14. The method of wafer cleaning of claim 12, wherein the flow rate of the cleaning solution sprayed from the second nozzle is fixed.

15. The method of wafer cleaning of claim 14, wherein the flow rate of the cleaning solution sprayed from the second nozzle is non-uniform.

16. The method of wafer cleaning of claim 12, wherein during the cleaning process the movement of the second nozzle is in static.

17. A wafer cleaning apparatus, comprising:
a wafer stage for hold a wafer, the wafer having a surface to be washed, the surface having a first given point and a second given point;
a first nozzle positioned on the wafer distant from the center of the wafer for spraying a clean solution onto the surface; and
a second nozzle positioned on the wafer near the center of the wafer for spraying the cleaning solution onto the surface, wherein the flow rate of the cleaning solution sprayed from the first nozzle is different from the flow rate of the cleaning solution sprayed from the second nozzle.

18. The wafer cleaning apparatus of claim 17, wherein the flow rate of the cleaning solution sprayed from the first nozzle is fixed, and the flow rate of the cleaning solution sprayed from the second nozzle is fixed.

19. The wafer cleaning apparatus of claim 17, wherein the first nozzle and the second nozzle are capable of moving horizontally back and forth independently.

20. The wafer cleaning apparatus of claim 19, wherein the first nozzle and the second nozzle are capable of moving in uniform motion.

21. The wafer cleaning apparatus of claim 19, wherein first nozzle and the second nozzle are capable of moving in non-uniform motion independently.

22. The wafer cleaning apparatus of claim 17, wherein the first nozzle and the second nozzle are fixed.
